(19) United States
(12) Patent Application Publication
(10) Pub. No.: US 2004/0162790 A1
(43) Pub. Date: Aug. 19, 2004

(54) Method and apparatus for identifying the role of an institution in a electronic financial transaction

(75) Inventor: David K. Fussell, Austin, TX (US)

Correspondence Address: Barry S. Newberger, 5400 Renaissance Tower, 1201 Elm Street, Dallas, TX, 75270, US

(73) Assignee: International Business Machines Corporation, Armonk, NY

(21) Appl. No.: 10/440,003

(22) Filed: Dec. 19, 2002

(51) Int. Cl. H04K 1/00

(52) U.S. Cl. 705/77

(57) ABSTRACT

A mechanism is presented for determining the role and model for a transaction in an electronic payment service in a business-to-business (B2B) e-commerce environment. The mechanism derives a transaction model and recipient institution role in response to data carried in the payment services messages themselves, including the entity initiating the message and the signatures contained in the message. In particular, it is not required that the model or role be specified in the payment service message itself.

### TECHNICAL FIELD

The present invention relates in general to data processing systems for financial transactions mediated over an Internetwork, and in particular to a data processing system and methods therein for determining the particular role of an institution and other attributes of the transaction.

### BACKGROUND INFORMATION

The advent of business-to-business (B2B) electronic commerce has led to the development of technologies for the automated payment transactions between buyers and sellers engaged in electronic commerce. In particular, mechanisms have been promulgated for the initiation of payments related to B2B e-commerce transactions using the Internet. One such technology is the Eleanor initiative. Eleanor is a set of specifications for implementing interoperable B2B electronic payment services which may be communicated between the parties using the Internet. Eleanor is promulgated by Identrus LLC, New York, N.Y., and the Eleanor specification may be obtained through it.

In a transaction conducted in accordance with the Eleanor mechanism, transactions are conveyed in messages in accordance with the Eleanor specifications. In any transaction, the entities that may participate are a buyer (“BU”), a seller (“SE”), a seller financial institution (“SFI”) and a buyer financial institution (“BFI”). Note that in a transaction, a particular financial institution might be acting on behalf of both the buyer and seller. That is, a particular buyer and seller pair could have the same financial institution. The entity whose behalf the financial institution is acting may be referred to as the “role” of the institution in any given transaction. The role in or an institution in a particular transaction may be as BFI, SFI, or as both BFI and SFI (“BOTH”).

Additionally, transactions may be initiated by either the seller or buyer. If initiated by the buyer, the transaction may, but need not, include securely signed information from the seller. (For the purposes herein, a securely signed information from the seller may be understood to be a digital signature which may be based on a public-key algorithm, and a trusted certification authority; the details of the signing algorithms are not required). Note that the source of a particular message may be any one of entities participating in a transaction, that is a buyer, seller, buyer's financial institution or seller's institution, and this may be independent of the initiator of the transaction. The initiator of the transaction may be signified in a message by the “model.” If the transaction is initiated by the Seller, the model may be referred to as a seller financial institution model (“SFIM”). Similarly, if the buyer initiated the transaction, the model referred to as the buyer financial institution model. There may be two submodels of the buyer financial institution model depending on whether the transaction is initiated by the buyer and signed by the seller, the buyer financial institution model with seller signature (“BFIMsig”) or, alternatively if unsigned by the seller, the buyer financial institution model without seller's signature (“BFIMnosig”). The model may be used, among other things, to allow a financial institution to distinguish the order in which messages must be forwarded between itself, its subscriber, or other financial institutions, or the types and order of the validity checks it must perform. Requests for payment in the BFIM model are usually instructions from a Buyer for the Buyer's financial institution to release money, whereas requests in the SFIM model are demands for payment from a Seller. The business process for dealing with these two types of transactions may be similar, but the model allows for differences in processing to be addressed.

The actions a financial institution is to perform with respect to a particular transaction depends on the role it is playing and the model being used in the transaction. Typically, the specifications for the payment mechanism, such as Eleanor, do not require that the role and model be included in the transaction messages. Consequently, there is a need in the art for systems and methods for determining the role and model for a particular transaction. In particular, there is a need in the art for a mechanism for determining the role and model relative to a particular transaction from the content of the payment messages themselves, in the context of a predetermined electronic payment service specification such as Eleanor.

### SUMMARY OF THE INVENTION

The aforementioned needs are addressed by the present invention. In one embodiment, a method of determining a role in an electronic payment service transaction may be provided. The method includes parsing a payment service message for identifier of a source of the payment service message and digital signatures included therein. The role of a recipient of the payment service message in response to at least one of a digital signature of a buyer included in the payment service message and a digital signature of a seller if the payment service message includes the digital signature of the seller. The participants in a transaction include one or more of a buyer, a seller, a seller's financial institution and a buyer's financial institution.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically illustrates an Internet worked e-commerce architecture which may be used in conjunction with the present invention;

FIG. 2 illustrates a data flow diagram for a transaction flow which may be used in conjunction with the present inventive principles;

FIGS. 3.1-3.3 illustrate, in flowchart form, a methodology for determining a transaction mode and role in accordance with an embodiment of the present invention and;

FIG. 4 illustrates, in block diagram form, a data processing system which may be used in an embodiment of the present invention.

### DETAILED DESCRIPTION

A mechanism is presented for determining the role and model for a current transaction in an electronic payment service. The mechanism generates a model and role in response to data specified to be carried in the transaction payment messages themselves, including the party initiating the message, and the signatures contained in the message. In particular, the present inventive principles do not require that the model or role be specified in the transaction payment message itself.

In the following description, numerous specific details are set forth such as specific message string values, etc. to provide a thorough understanding in the present invention. However, it will be recognized to those of skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art. Refer now to the drawings wherein depicted elements are not necessarily shown to scale and wherein like or similar views are designated by the same reference numeral through the several views.

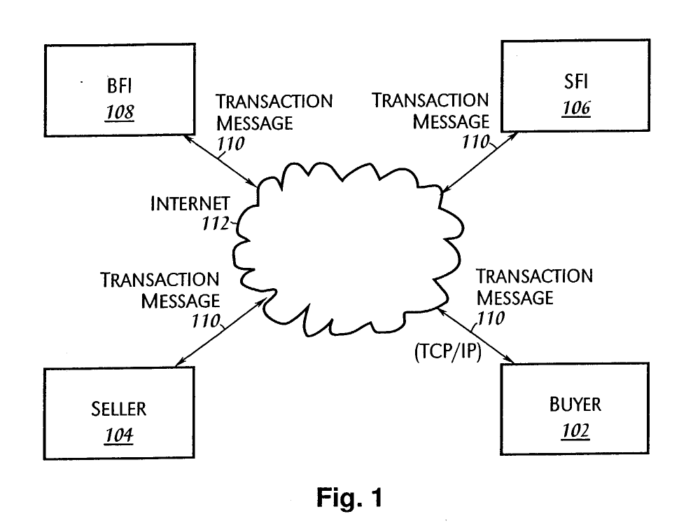

An architecture for Internet worked B2B e-commerce transactions Which may be used in conjunction with the present invention is schematically illustrated in FIG. 1. As previously discussed, the set of participants in a particular transaction may include a buyer 102, seller 104, seller's financial institution (“SFI”) 106 and a buyer's financial institution (“BFI”) 108. A transaction between a buyer and a seller and the initiation of a payment therefore may be effected electronically by an exchange of payment transactions messages 110 (or simply “messages”) between the parties. Messages may contain data in accordance with a predetermined specification to insure interoperability, such as the Eleanor specification. The data may further be encapsulated in accordance with a transport protocol to facilitate the transfer of the data over a network such as Internet 112. Standardized protocols include the Transmission Control Protocol/Internet Protocol (TCP/IP) suite. Those of ordinary skill in the relevant art would appreciate that the particular network transfer protocol used to transfer the encapsulated transaction information is independent of the nature of the encapsulated data itself that is governed by the particular electronic payment system specifications and vice versa.

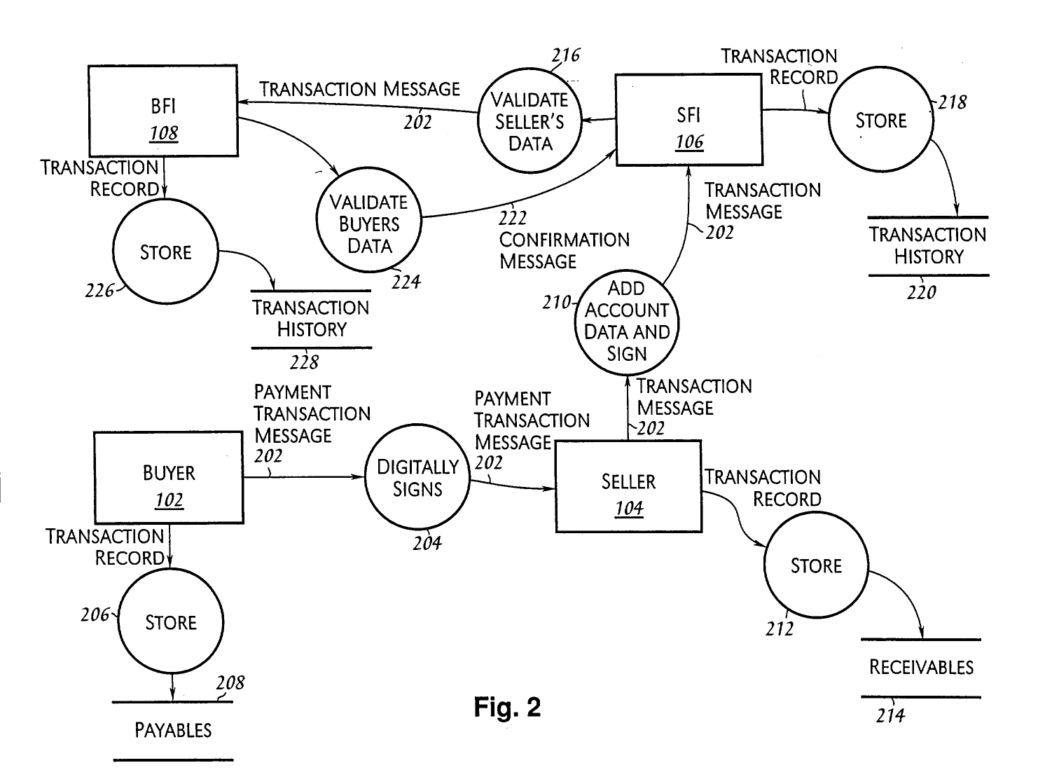

Transaction payment mechanisms which may be used in conjunction with the present inventive principles may be further understood by referring now to FIG. 2 illustrating a data flow diagram for representative transaction. For the present purposes, the communications between the buyer and seller with respect to the submission of an order, or response to an offer for sale, or similar elements of the transaction do not implicate the present inventive principles, and have not been shown in the data flow diagram. The data flow in FIG. 2 focuses on the initiation of the payment process with respect to an electronic payment service.

In the electronic payment data flow of FIG. 2, payment transaction message 202 from buyer 102 is digitally signed, operation 204 and forwarded to seller 104. The message source may be denoted as the buyer by a string value “BU” in the message itself. Additionally, buyer 102 may store, operation 206, a transaction record in payables database 208.

Seller 104 adds its account data to transaction message 202, and optionally, signs the message, operation 210. The transaction message is forwarded to SFI 106, and the message source becomes the seller. Additionally, seller 104 may store a transaction record, operation 212, in receivables database 214.

The SFI validates seller's data, operation 216, and forwards the message to BFI 108. Additionally, the SFI may store, operation 218, a copy of the transaction record in a transaction history database 220.

The BFI validates the buyer's data and generates a confirmation message 222, operation 224. The message source may be denoted as the buyer's financial institution by a string value “BFI” in the message itself. The confirmation message is returned to SFI 106. BFI 108 may also store a transaction record, operation 226, in a transaction history base 228. Note that in such an electronic payment system, the settlement of the payments whereby the seller's account is credited and the buyer's account debited may be performed using existing inter-bank settlement systems.

As noted previously, the transaction messages may be digitally signed by one or more of the parties. Those of ordinary skill in the art would appreciate that a digital signature is a mechanism by which the authenticity of the signed message may be verified. Typically, a digital signal signature includes a numerical value derived from the message itself (commonly referred to as a message digest) which is smaller in length that the original message. The message digest may then be encrypted using a public-key or equivalently, asymmetric, encryption algorithm to generate the digital signature. An asymmetric cryptographic algorithm includes a key pair, referred to as the public key and the private key in which a plaintext enciphered using one of the keys of the pair is decrypted by the other key of the pair. To ensure that a public key belongs to a particular issuer, a trusted agent, commonly referred to as a Certificate Authority (CA) may be used to generate and assign certificates. A certificate may identify the CA and includes the signer's name and its public key. The certificate is then digitally signed by the CA (the signer may also be referred to as the subject).

One mechanism for authentication across networks that conforms to this architecture and which may be used in conjunction with the present invention has been promulgated by the International Organization for Standardization (IOS) as the X.509 protocol. In an X.509 implementation, the CA maintains a database, structured as a directory, of certificates. To verify a digital signature, the recipient of a message retrieves the certificate containing the subject's public key from the CA. The certificate may be obtained using its Distinguished Name (DN), which is included in the signature. The DN the certificate is a set of attribute values that identify a path in a directory tree from the certificate to base of the directory tree, which thus identifies the issuer of the certificate.

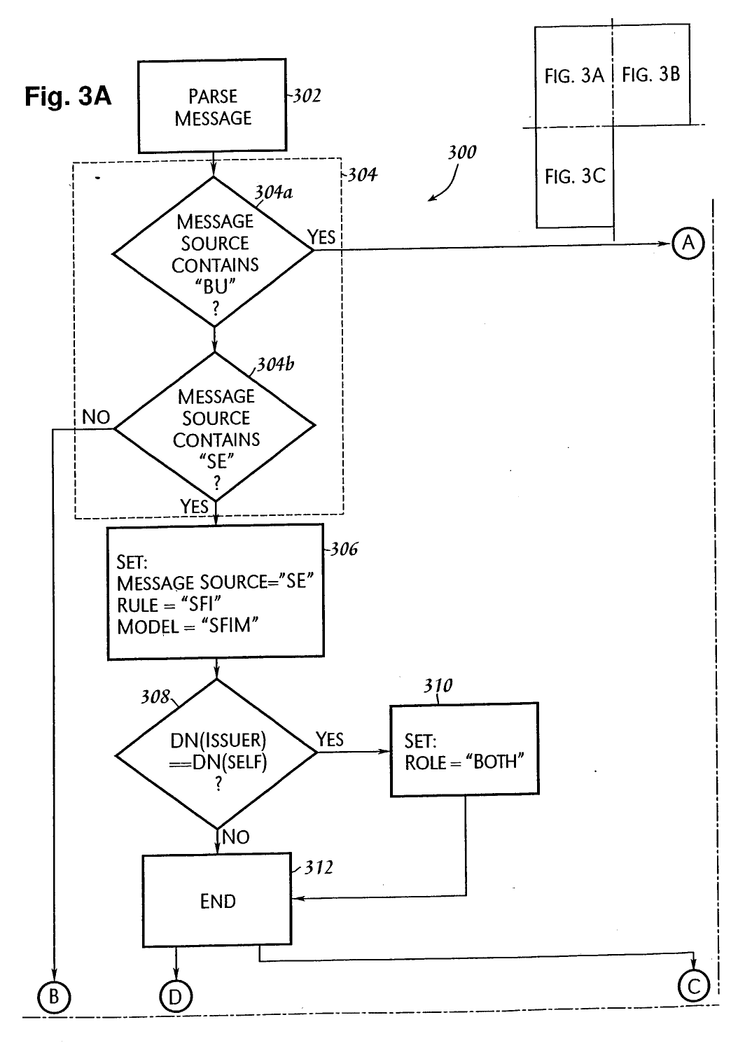

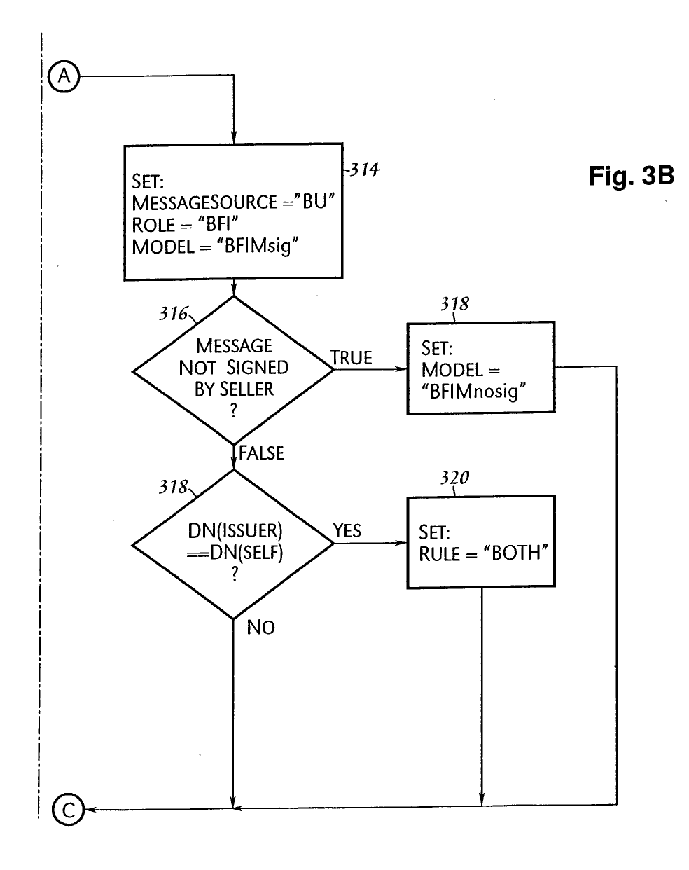

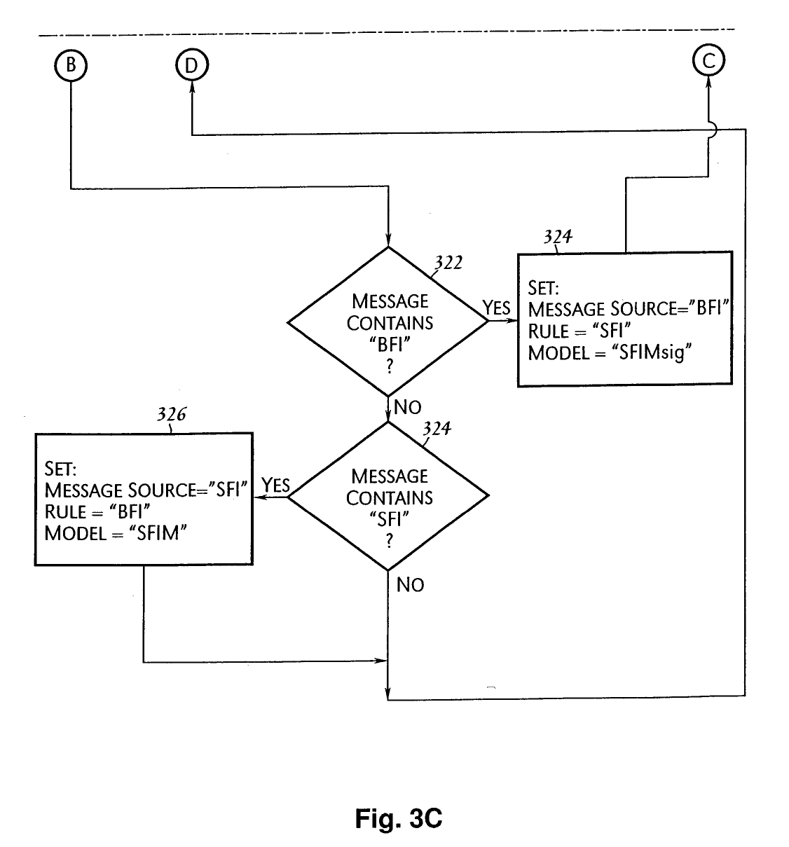

Referring now to FIGS. 3.1-3.3, there is illustrated therein methodology 300 for determining the role and model with respect to a payment transaction using the contents of the transaction message. In step 302, the message is parsed, and in step 304, which may include decision blocks 304a and 304b, a message source string is tested. If the message source contains a symbol denoting the source as the buyer (“BU”) then step 304 proceeds by the “Yes” branch of decision block 304a, to step 314 discussed in conjunction with FIG. 3.2. Otherwise step 304 proceeds to decision block 304b. If, in block 304b, the message source contains a symbol denoting the seller as source (“SE”), step 304 proceeds by the “Yes” branch of block 304 to step 306. Otherwise, step 304b proceeds by the “No” branch of block 304b, discussed in conjunction with FIG. 3.3.

Considering now the operation of methodology 300 if the message source corresponds to the seller in block 304b. In step 306, the message source is set to “SE”, the role is set to the seller financial institution (“SFI”), and the model is set to seller financial institution model (“SFIM”).

In step 308, the issuer of the digital signature associated with the buyer is tested. In particular, the identity of the issues of the certificate, i.e., the CA is compared with the CA that issues the message recipient's certificate. (The message recipient is the entity that may use methodology 300 to determine its role and transaction model.) In an embodiment in accordance with the X.509 protocol, the identity of the CA may be provided by the Distinguished Name (DN) of the certificate. If the distinguished name of the issuer (DN(Issuer)) is the same as the distinguished name of the message recipient, (DN(Self)), then the role is reset to “BOTH” in step 310. Methodology 300 terminates in step 312. If however, in step 308, the distinguished name of the issuer is not the distinguished name of the recipient, step 310 is bypassed.

Returning the step 304 and decision block 304a, if in block 304a the message source denotes the buyer, methodology 300 proceeds to step 314 (FIG. 3.2). In step 314, the message source is set to “BU”, the role is set to “SFI” and model is set to banker's financial institution model with seller's signature (“BFIMsig”). In step 316, if the message is not signed by the seller, that is no seller signature is included in the message, in step 318, the model is reset to buyer financial institution model without seller's signature (“BFIMnosig”). Otherwise, in step 316, if the message is signed by the seller, step 316 proceeds by the “False” branch and in step 318, it is determined if the issuer of the certificate is the same as the issuer of the certificate of recipient of the message. As previously discussed, in an embodiment in accordance with the X.509 protocol, this may be performed by comparing DN (Issuer) with (DN(Self)). if these are the same, then in step 320 the role is reset to “BOTH.” In other words, the role of the recipient institution is both the buyer's financial institution and seller's financial institution. If, however, in step 318 the distinguished names, or other identifier of the issuers of the certificates are different, step 320 is bypassed. Methodology 300 terminates in step 312.

Returning to step 304, FIG. 3.1, if in block 304a the message source does not contain a symbol designating the buyer as source, and in block 304b, the message source does not contain a symbol identifying the seller as the message source, step 304 proceeds by the “No” branch of block 304b. In step 322, FIG. 3.3, it is determined if the corresponding message field includes a symbol representing the buyers financial institution (“BFI”). If so, in step 324 the message source is set to “BFI”, the role is set to “SFI”, and the model is set to “BFIMsig.” Methodology 300 terminates in step 312.

Otherwise, methodology 300 proceeds by the “No” branch of step 322, and in step 324, it is determined if the message includes a symbol denoting the seller's financial institution as the source of the message (“SFI”). If so, in step 326, the message source is set to “SFI”, the role to “BFI” and the model to “SFIM.” Process 300 then terminates in step 312. If, however, the message does not denote the seller's financial institution as the source in step 324, methodology 300 terminates in step 312 wherein the message is rejected as badly constructed.

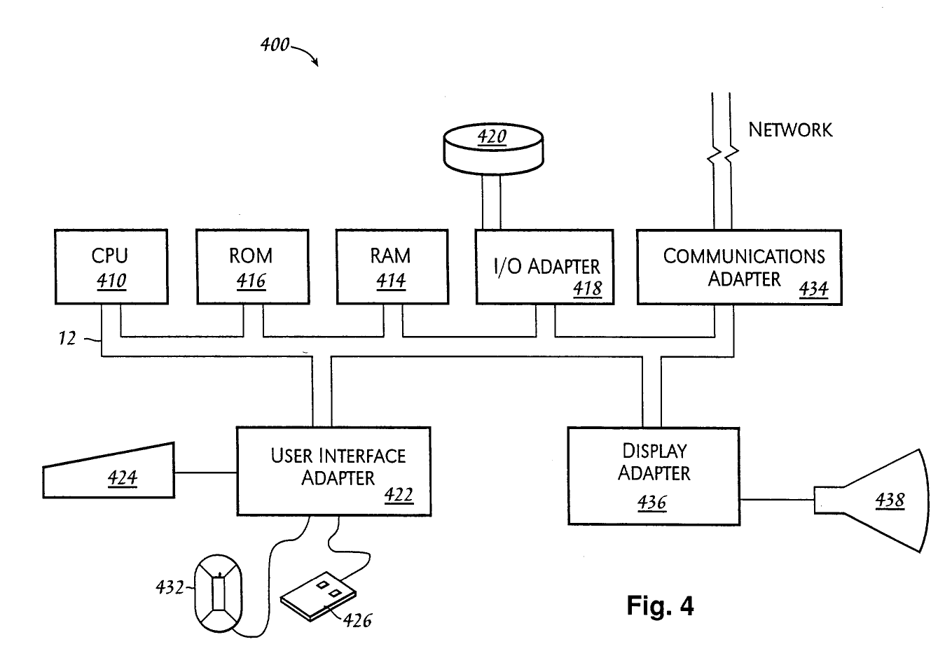

A data processing system which may be used in conjunction with the methodology of FIGS. 3.1-3.3, is illustrated in FIG. 4. FIG. 4 illustrates an exemplary hardware configuration of data processing system 400 in accordance with the subject invention. The system in conjunction with methodology 300, may be used to derive the properties of a transaction, such as the Model and the Role from the data value in a transaction message specifying the initiator and signature information. Data processing system 400 includes central processing unit (CPU) 410, such as a conventional microprocessor, and a number of other units interconnected via system bus 412. Data processing system 400 also includes random access memory (RAM) 414, read only memory (ROM) 416 and input/output (110) adapter 418 for connecting peripheral devices such as disk units 420 to bus 412, user interface adapter 422 for connecting keyboard 424, and/or other user interface devices (not shown) to bus 412. System 400 also includes communication adapter 434 for connecting data processing system 400 to a data processing network, enabling the system to communicate with other systems, and display adapter 436 for connecting bus 412 to display device 438. CPU 410 may include other circuitry not shown herein, which will include circuitry commonly found within a microprocessor, e.g. execution units, bus interface units, arithmetic logic units, etc. CPU 410 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 414 of one or more computer systems configured generally as described above. These sets of instructions, in conjunction with system components that execute them may derive the aforementioned transaction parameters. Until required by the computer system, the set of instructions may be stored as a computer program product in another computer memory, for example, in disk drive 420 (which may include a removable memory such as an optical disk, floppy disk or CD-ROM for eventual use in the disk drive 420). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

In this way, a mechanism for determining the role of an institution in an electronic financial payment transaction is provided. In particular, in accordance with the present inventive principles, the role of the institution and the transaction model may be derived from the source of the message and digital signatures incorporated therein.

Although the present invention and its advantages have been described in detail, it should be understood that various changes, substitutions and alterations can be made herein without departing from the spirit and scope of the invention as defined by the appended claims.

What is claimed is:

1. A method of determining a role in an electronic payment service transaction comprising:
parsing a payment service message;
obtaining an identifier of a source of the payment service message in response to the parsing step;
determining the role of a recipient of the payment service message in response to at least one of a digital signature of a buyer included in the payment service message and a digital signature of a seller if the payment service message includes the digital signature of the seller, wherein the participants in a transaction include a buyer, a seller, a seller's financial institution and a buyer's financial institution.

2. The method of claim 1 further comprising determining the source of a transaction message using the source identifier;
determining if the payment service message contains a digital signature of the seller, if the identifier of the source denotes the buyer;
if the transaction message contains a digital signature of the seller, determining if the issuer of a certificate including the digital signature is the issuer of a certificate corresponding to the digital signature of a recipient of the message; and
setting the role of the recipient to be both a seller's financial institution and a buyer's financial institution if the issuer of a certificate including the digital signature is the issuer of a certificate corresponding to the digital signature of a recipient of the message.

3. The method of claim 2 further comprising setting the model to buyer's financial institution with signature if the payment service message contains a digital signature of the seller.

4. The method of claim 2 further comprising:
setting the model to buyer's financial institution without signature if the payment service message does not contain a digital signature of the seller;
setting the role to buyer's financial institution, if the issuer of a certificate including the digital signature is not the issuer of a certificate corresponding to the digital signature of a recipient of the message.

5. The method of claim 1 further comprising determining the source of a transaction message using the source identifier, and, if the identifier of the source denotes the seller:
determining if the issuer of a certificate including the digital signature is the issuer of a certificate corresponding to the digital signature of a recipient of the message; and
setting the role of the recipient to be both a seller's financial institution and a buyer's financial institution if the issuer of a certificate including the digital signature is the issuer of a certificate corresponding to the digital signature of a recipient of the message.

6. The method of claim 5 further comprising:
setting the model to seller's financial institution; and
setting the role of the recipient to be seller's financial institution if the issuer of a certificate including the digital signature is not the issuer of a certificate corresponding to the digital signature of a recipient of the message.

7. A computer program product embodied in a tangible storage medium for determining a role in an electronic payment service transaction comprising programming instructions for:
parsing a payment service message;
obtaining an identifier of a source of the payment service message in response to the parsing step; and
determining the role of a recipient of the payment service message in response to at least one of a digital signature of a buyer included in the payment service message and a digital signature of a seller if the payment service message includes the digital signature of the seller, wherein the participants in a transaction include a buyer, a seller, a seller's financial institution and a buyer's financial institution.

8. The program product of claim 7 further comprising programming instructions for: determining the source of a transaction message using the source identifier;
determining if the payment service message contains a digital signature of the seller, if the identifier of the source denotes the buyer;
if the transaction message contains a digital signature of the seller, determining if the issuer of a certificate including the digital signature is the issuer of a certificate corresponding to the digital signature of a recipient of the message; and
setting the role of the recipient to be both a seller's financial institution and a buyer's financial institution if the issuer of a certificate including the digital signature is the issuer of a certificate corresponding to the digital signature of a recipient of the message.

9. The program product of claim 8 further comprising programming instructions for setting the model to buyer's financial institution with signature if the payment service message contains a digital signature of the seller.

10. The program product of claim 8 further comprising programming instructions for:
setting the model to buyer's financial institution without signature if the payment service message does not contain a digital signature of the seller; and
setting the role to buyer's financial institution, if the issuer of a certificate including the digital signature is not the issuer of a certificate corresponding to the digital signature of a recipient of the message.

11. The program product of claim 7 further comprising programming instructions for determining the source of a transaction message using the source identifier, and, if the identifier of the source denotes the seller:
determining if the issuer of a certificate including the digital signature is the issuer of a certificate corresponding to the digital signature of a recipient of the message; and
setting the role of the recipient to be both a seller's financial institution and a buyer's financial institution if the issuer of a certificate including the digital signature is the issuer of a certificate corresponding to the digital signature of a recipient of the message.

12. The program product of claim 11 further comprising programming instructions for:
setting the model to seller's financial institution; and
setting the role of the recipient to be seller's financial institution if the issuer of a certificate including the digital signature is not the issuer of a certificate corresponding to the digital signature of a recipient of the message.

13. The program product of claim 7 further comprising programming instructions
setting the model to buyer's financial institution with signature and the role to seller's financial institution if the source identifier denotes buyer's financial institution and;
setting the model to seller's financial institution and the role to buyer's financial institution if the source identifier denotes seller's financial institution.

14. A data processing system for determining a role in an electronic payment service transaction comprising:
circuitry operable for parsing a payment service message;
circuitry operable for obtaining an identifier of a source of the payment service message in response to the parsing step; and
circuitry operable for determining the role of a recipient of the payment service message in response to at least one of a digital signature of a buyer included in the payment service message and a digital signature of a seller if the payment service message includes the digital signature of the seller, wherein the participants in a transaction include a buyer, a seller, a seller's financial institution and a buyer's financial institution.

15. The system of claim 14 further comprising:
circuitry operable for determining if the payment service message contains a digital signature of the seller, if the identifier of the source denotes the buyer;
circuitry operable for determining if the issuer of a certificate including the digital signature is the issuer of a certificate corresponding to the digital signature of a recipient of the message, if the transaction message contains a digital signature of the seller; and
circuitry operable for setting the role of the recipient to be both a seller's financial institution and a buyer's financial institution if the issuer of a certificate including the digital signature is the issuer of a certificate corresponding to the digital signature of a recipient of the message.

16. The system of claim 15 further comprising circuitry operable for setting the model to buyer's financial institution with signature if the payment service message contains a digital signature of the seller.

17. The system of claim 15 further comprising:
circuitry operable for setting the model to buyer's financial institution without signature if the payment service message does not contain a digital signature of the seller; and
circuitry operable for setting the role to buyer's financial institution, if the issuer of a certificate including the digital signature is not the issuer of a certificate corresponding to the digital signature of a recipient of the message.

18. The system of claim 14 further comprising circuitry operable for determining the source of a transaction message using the source identifier, and, if the identifier of the source denotes the seller:
determining if the issuer of a certificate including the digital signature is the issuer of a certificate corresponding to the digital signature of a recipient of the message; and
setting the role of the recipient to be both a seller's financial institution and a buyer's financial institution if the issuer of a certificate including the digital signature is the issuer of a certificate corresponding to the digital signature of a recipient of the message.

19. The system of claim 18 further comprising:
circuitry operable for setting the model to seller's financial institution; and
circuitry operable for setting the role of the recipient to be seller's financial institution if the issuer of a certificate including the digital signature is not the issuer of a certificate corresponding to the digital signature of a recipient of the message.

20. The system of claim 14 further comprising:
circuitry operable for setting the model to buyer's financial institution with signature and the role to seller's financial institution if the source identifier denotes buyer's financial institution and;
circuitry operable for setting the model to seller's financial institution and the role to buyer's financial institution if the source identifier denotes seller's financial institution.
